(19) United States
(12) Patent Application Publication
(10) Pub. No.: US 2025/0028751 A1
(43) Pub. Date: Jan. 23, 2025

(54) DIALOGUE SKELETON ASSISTED PROMPT TRANSFER FOR DIALOGUE SUMMARIZATION

(71) Applicant: Adobe Inc., San Jose, CA (US)

(72) Inventors: Tong Yu, Fremont, CA (US); Kaige Xie, Atlanta, GA (US); Haoliang Wang, Sunnyvale, CA (US); Junda Wu, Long Island City, NY (US); Handong Zhao, Cupertino, CA (US); Ruiyi Zhang, San Jose, CA (US); Kanak Vivek Mahadik, San Jose, CA (US); Ani Nenkova, Philadelphia, PA (US)

(73) Assignee: Adobe Inc., San Jose, CA (US)

(21) Appl. No.: 18/355,901

(22) Filed: Jul. 20, 2023

(51) Int. Cl. G06F 16/34; G06F 40/35

(52) U.S. Cl. CPC G06F 16/345; G06F 40/35

(57) ABSTRACT

Dialogue skeleton assisted prompt transfer for dialogue summarization techniques are described that support training of a language model to perform dialogue summarization in a few-shot scenario. A processing device, for instance, receives a training dataset that includes training dialogues. The processing device then generates dialogue skeletons based on the training dialogues using one or more perturbation-based probes. The processing device trains a language model using prompt transfer between a source task, e.g., dialogue state tracking, and a target task, e.g., dialogue summarization, using the dialogue skeletons as supervision. The processing device then receives an input dialogue and uses the trained language model to generate a summary of the input dialogue.

### BACKGROUND

Natural language processing techniques and models are used for a variety of tasks such as text understanding, speech recognition, text generation, etc. For example, machine learning models are commonly used for text summarization tasks, such as to receive a body of text and generate a concise summary of the text. However, conventional text summarization models rely on extensive annotated data to update parameters of the models during training, which is not practical to collect for some domains and is computationally expensive. Accordingly, such conventional models perform poorly when used in unfamiliar domains. For instance, summaries generated by conventional text summarization models often fail to include relevant information in summaries for documents from unseen domains.

### SUMMARY

Techniques for dialogue skeleton assisted prompt transfer for dialogue summarization are described. In an example, a processing device implements a content processing system to receive a training dataset that includes a plurality of training dialogues. The content processing system then generates dialogue skeletons based on the training dialogues using one or more perturbation-based probes. The perturbation-based probes are configured to determine a sensitivity of a machine learning model to individual dialogue turns of the training dialogues, and the dialogue skeletons are generated as a subset of dialogue turns from the training dialogues that that are above a threshold level of sensitivity.

The content processing system then trains a language model using prompt transfer between a source task, e.g., dialogue state tracking, and a target task, e.g., dialogue summarization, using the training dialogues as well as the dialogue skeletons as supervision. The prompt transfer includes freezing parameters of the language model, training a soft prompt in the source task, using it to initialize parameters of a soft prompt for the target task, and refining the soft prompt for the target task. The content processing system receives an input dialogue and uses the trained language model to generate a summary of the input dialogue by incorporating the soft prompt into an input sequence for the language model. In this way, the techniques described herein provide a modality to generate summaries of dialogues that incorporate dialogue state information in a few-shot scenario.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the dialogue skeleton assisted prompt transfer for dialogue summarization techniques described herein.

FIG. 2 depicts a system in an example implementation showing operation of a summarization module in greater detail.

FIG. 3 depicts an example of an algorithm to generate one or more dialogue skeletons.

FIG. 4 depicts an example to configure a language model to perform dialogue summarization using dialogue skeletons as additional supervision.

FIG. 5 depicts an example of generation of summaries of an input dialogue using models configured with a variety of training schemes in accordance with the techniques described herein.

FIG. 6 is a flow diagram depicting an algorithm as a step-by-step procedure in an example implementation that is performable by a processing device to generate a summary of a dialogue.

FIG. 7 is a flow diagram depicting an algorithm as a step-by-step procedure in an example implementation that is performable by a processing device to train a language model for dialogue summarization using dialogue skeleton supervised prompt transfer.

FIG. 8 illustrates an example system including various components of an example device that can be implemented as any type of computing device as described and/or utilized with reference to FIGS. 1-7 to implement embodiments of the techniques described herein.

### DETAILED DESCRIPTION

### Overview

Text summarization models are a type of natural language processing model that are designed to receive a corpus of text, e.g., a document, and generate a concise and coherent summary of the text. The goal of text summarization models is to distill relevant information from the text into a brief format while preserving its key content. These models support user efficiency, content organization, and data analysis which makes them useful tools in the field of natural language processing. Training text summarization models typically involves use of large amounts of labeled training data to adjust parameters of transformers of the text summarization model itself. However, these training approaches are computationally demanding, and acquiring sufficient summarization training data is costly, time-consuming, and not practical to collect in a variety of real-world contexts. Thus, conventional text summarization models often fail to include relevant information in summaries for input documents from unfamiliar domains.

One approach that has been proposed to address issues related to training data scarcity is transfer learning. Generally, transfer learning leverages information from one machine learning task to inform a different machine learning task. For instance, transfer learning includes leveraging information from a first task, in which training data is readily available, to inform learning for a second task, for which training data is scarce. However, conventional transfer learning techniques are generally not effective for language generation tasks such as dialogue summarization. Further, such techniques are constrained by a similarity between the first task and the second task. For instance, conventional transfer learning techniques do not work on relatively dissimilar tasks and thus have limited utility.

Accordingly, techniques and systems for dialogue skeleton assisted prompt transfer for dialogue summarization are described that overcome these technical challenges and limitations to train a language model to generate summaries of dialogues that incorporate dialogue state information in a few-shot context. To overcome issues related to data scarcity, the techniques described herein leverage information from a source natural language processing task, e.g., dialogue state tracking (DST), to inform a target natural language processing task, e.g., dialogue summarization, using a prompt transfer approach. The techniques described herein further generate dialogue skeletons that serve as an intermediate task specific medium to “bridge the gap” between the source task and the target task to enhance model performance.

In an example to do so, a processing device implements a content processing system to receive a training dataset that includes a plurality of training dialogues. The training dialogues each include a transcript of a conversation and ground truth annotations for one or more machine learning tasks. For instance, the training dialogues include training summaries related to a dialogue summarization task that represent concise representations of key information from the training dialogues. However, training summaries are computationally expensive to generate, and are unavailable for a variety of domains. Thus, the training summaries represent a “few-shot” context.

The training dialogues further include dialogue state annotations for a DST task. Dialogue state annotations, for instance, include information such as a user's goal, a query, a task being discussed, a context of a portion of the dialogue, relevant entities or attributes, key data or information that has been provided, etc. for dialogue turns of the training dialogues. Thus, the dialogue state annotations relate to dialogue summarization in that dialogue states are expected to be included in a summary of a dialogue, e.g., to convey key information from the dialogue. Further, dialogue state annotations are readily available for a wide variety of domains and are computationally inexpensive to obtain.

The content processing system is thus operable to leverage the dialogue state annotations to inform the dialogue summarization task. However, even though DST and dialogue summarization embody similar concepts, there is a domain shift between DST (which is typically framed as a language understanding task) and dialogue summarization (which is a language generation task) that inhibits conventional knowledge transfer. Accordingly, the content processing system treats DST as a sequence-to-sequence generation task to promote knowledge transfer between the two tasks. Further, the content processing system generates one or more dialogue skeletons that serve as an intermediate task-specific medium during training to connect DST with dialogue summarization.

For instance, the content processing system generates the dialogue skeletons based on the training dialogues. Generally, the dialogue skeletons include dialogue turns (e.g., one or more sentences/utterances) that a machine learning model is sensitive to, e.g., dialogue turns that strongly influence the output of the model. To generate the dialogue skeletons, the content processing system generates one or more perturbation-based probes that are configured to determine a sensitivity of the machine learning model to individual dialogue turns of the training dialogues. The content processing system then generates a dialogue skeleton for each training dialogue that includes dialogue turns that are above a threshold level of sensitivity.

The content processing system trains a language model to perform dialogue summarization using prompt transfer between a source task and a target task. In this example, the training includes freezing parameters of the language model and learning a soft prompt, which is incorporated into an input sequence during subsequent inferencing to guide the model towards desirable outputs. The prompt transfer approach includes training a soft prompt in the source task, e.g., DST, and using it to initialize parameters of a soft prompt for the target task, e.g., dialogue summarization. The content processing system then refines the soft prompt for the target task.

To increase the overlap between the source task and the target task, the content processing system incorporates a skeleton generation task using the dialogue skeletons as additional supervision for the source task and/or the target task during prompt transfer. Further, incorporation of the dialogue skeletons as extra supervision (in addition to the dialogue state annotations and training summaries) preserves information learned during training on the source task. In this way, the techniques described herein overcome conventional limitations related to data scarcity and train the language model to incorporate dialogue state information during generation of dialogue summaries.

The content processing system is then operable to receive an input dialogue and generate a summary of the dialogue using the trained language model. The dialogue, for instance, includes a transcript of a conversation between two or more parties. In this example, the content processing system generates an input sequence based on the input dialogue and the soft prompt generated during training. The content processing system then feeds the input sequence to the language model to generate the summary. The summary includes relevant information from the input dialogue and represents key content of the input dialogue in a concise manner. Further, because the language model is trained using the dialogue skeletons to preserve model capability during prompt transfer, the summary includes relevant dialogue state information which is not possible using conventional techniques.

Further discussion of these and other examples and advantages are included in the following sections and shown using corresponding figures. In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

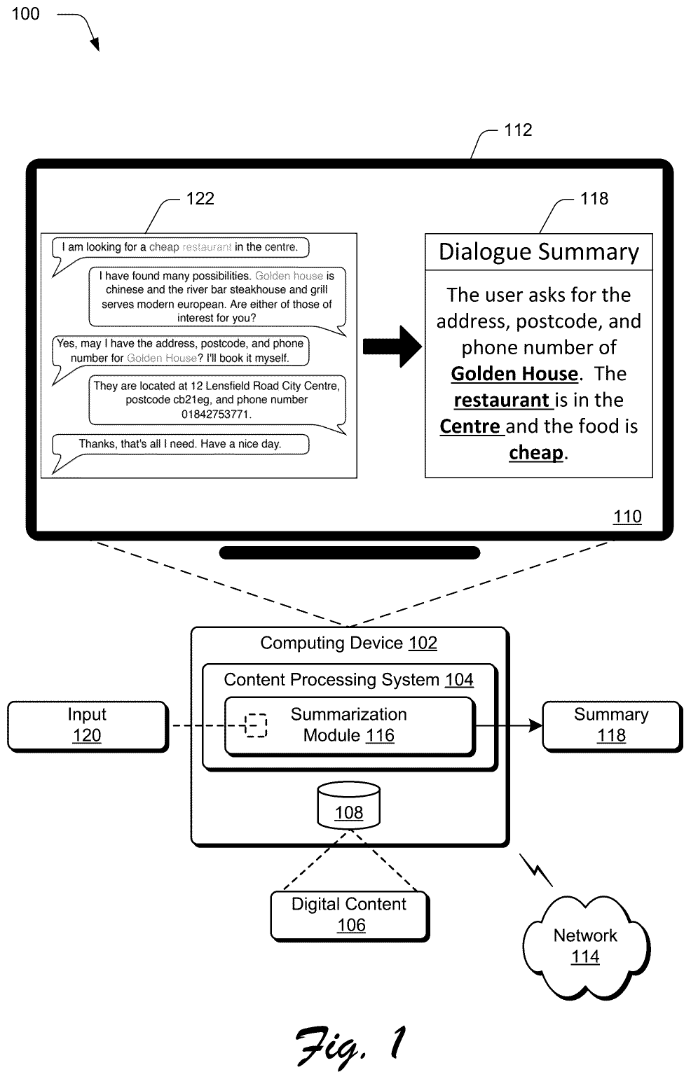

FIG. 1 is an illustration of a digital medium environment 100 in an example implementation that is operable to employ the dialogue skeleton assisted prompt transfer for dialogue summarization techniques described herein. The illustrated environment 100 includes a computing device 102, which is configurable in a variety of ways.

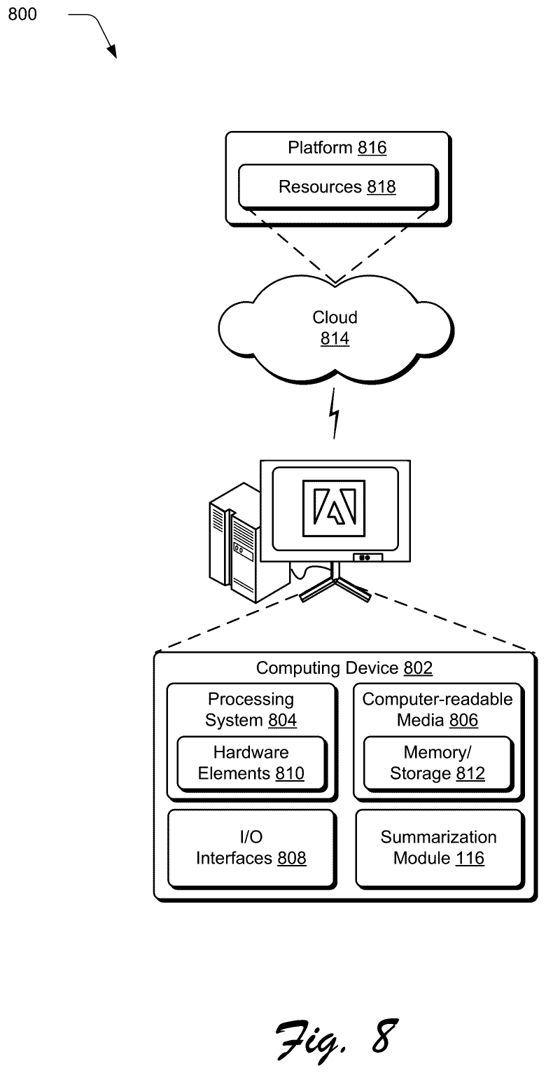

The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory and processor resources and/or components (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform and/or cause operations to be performed “over the cloud” as described in FIG. 8.

The computing device 102 is illustrated as including a content processing system 104. The content processing system 104 is implemented at least partially in hardware of the computing device 102 to process and transform digital content 106, which is illustrated as maintained in storage 108 of the computing device 102. Such processing includes creation of the digital content 106, summarization of the digital content 106, transformation of the digital content 106, modification of the digital content 106, and rendering of the digital content 106 in a user interface 110 for output, e.g., by a display device 112. Although illustrated as implemented locally at the computing device 102, functionality of the content processing system 104 is also configurable in whole or in part via functionality available via a network 114, such as part of a web service or “in the cloud.”

An example of functionality incorporated by the content processing system 104 to process the digital content 106 is illustrated as a summarization module 116. The summarization module 116 is configured to generate a summary 118 of an input 120 that includes text, such as a dialogue 122. Generally, the summary 118 represents a condensed version of the text of the input 120 and includes relevant information, key details, and/or main ideas of the input 120. In the illustrated example, the dialogue 122 represents a transcript of a conversation between two parties, e.g., a user and an agent, that pertains to a request from the user for a dinner recommendation. The transcript includes domain-specific information, however labelled training data for dialogue summarization is unavailable for this particular domain. Accordingly, conventional techniques for text summarization generate inaccurate and/or incomplete summaries for such inputs.

Thus, the summarization module 116 leverages information from a source task, e.g., dialogue state tracking (DST), in which training data is readily available for the particular domain to augment the performance of a machine learning model on a target task, e.g., dialogue summarization, to overcome limitations related to data scarcity. For instance, the summarization module 116 leverages a prompt transfer training approach between the source task and the target task. To effectively pass information between DST and dialogue summarization, the summarization module 116 further generates one or more dialogue skeletons of training dialogues that are used as additional supervision during training. The dialogue skeletons act as an intermediate task-specific medium that preserves machine learning model capability during prompt transfer. In this way, the summarization module 116 is able to bridge the gap between the source task and the target task to configure a machine learning model for dialogue summarization in a few-shot context.

For instance, in the illustrated example the summarization module 116 generates the summary 118 that is a concise representation of relevant information from the dialogue 122. The summary 118 describes the conversation and includes key information such as a name of the restaurant (e.g., Golden House), a price range for the restaurant (e.g., cheap) and a location of the restaurant, e.g., in the Centre. In this example, the bolded words represent dialogue state-related information from the dialogue 122. Thus, the techniques described herein support enhanced dialogue summarization in a few-shot scenario that incorporates dialogue state information. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Dialogue Skeleton Assisted Prompt Transfer for Dialogue Summarization

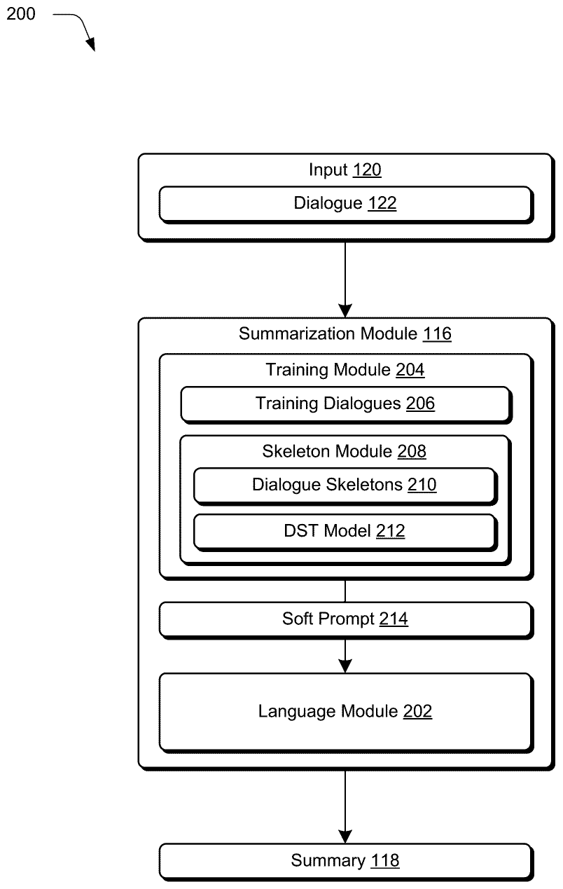

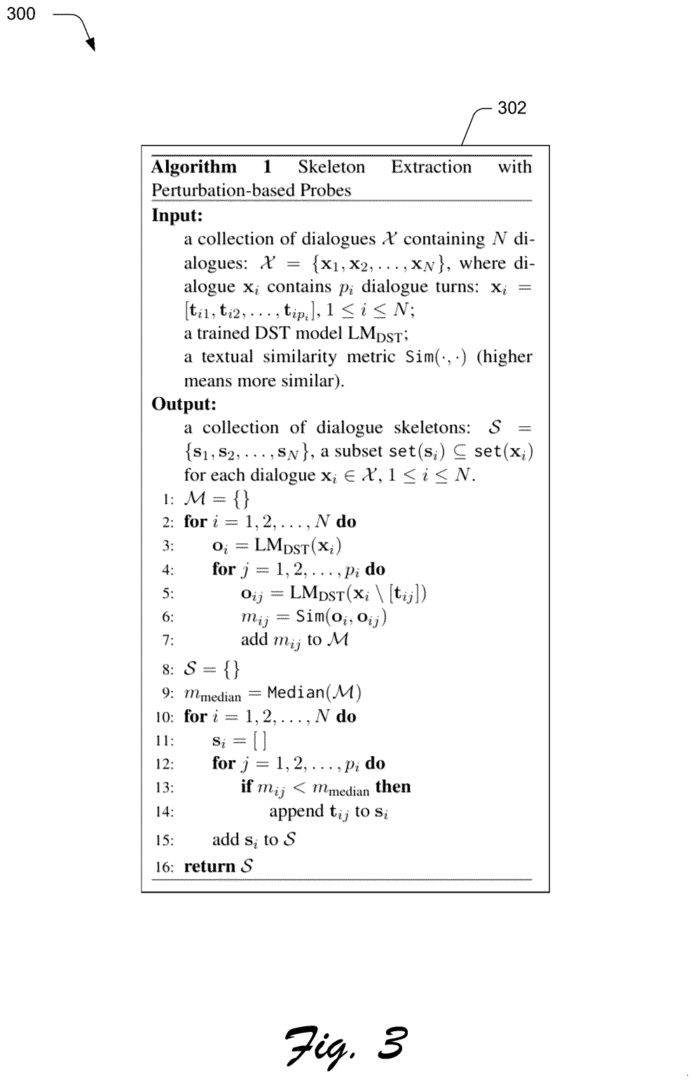

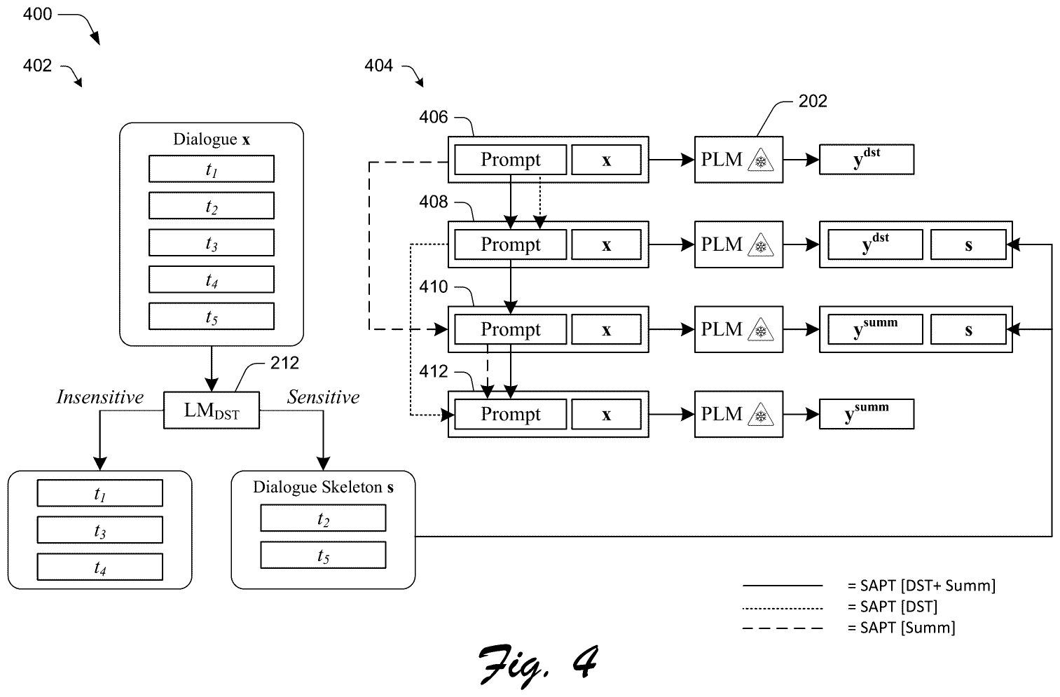

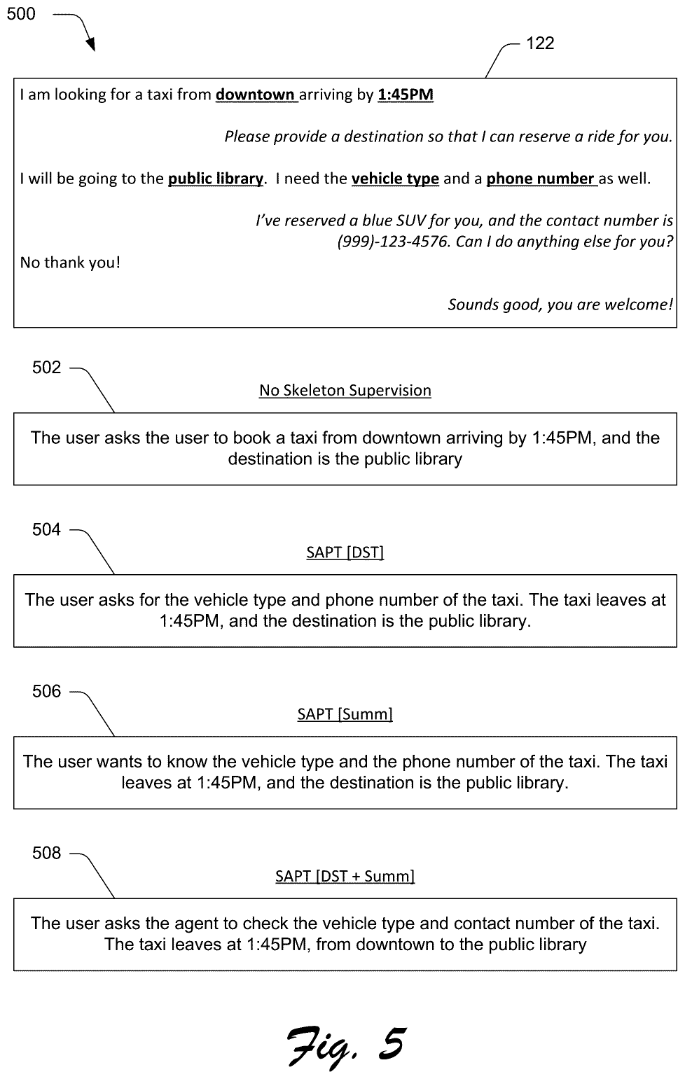

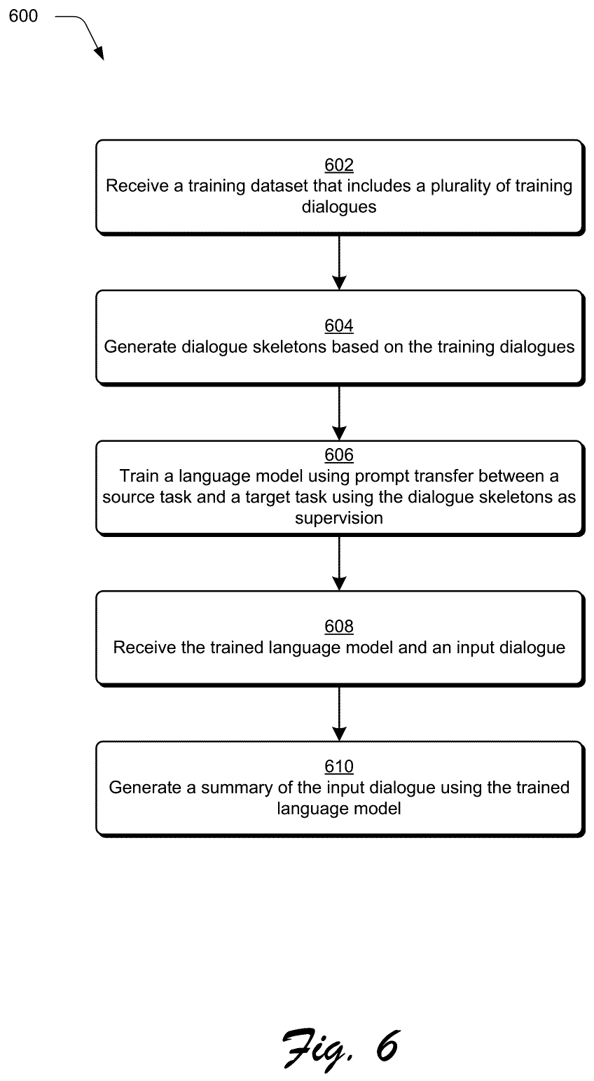

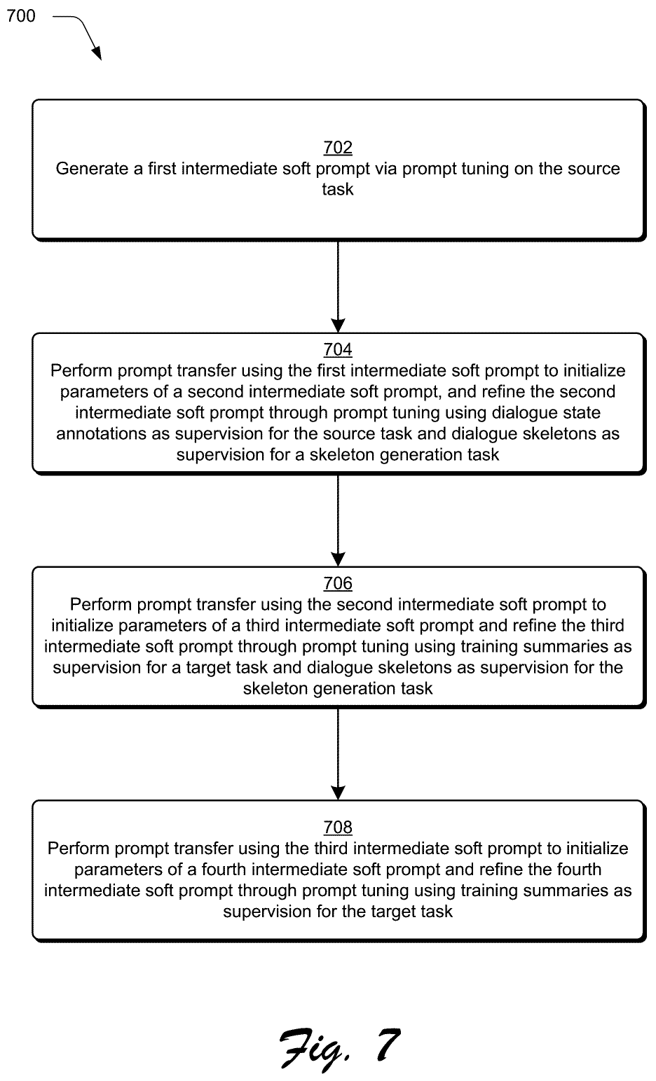

FIG. 2 depicts a system 200 in an example implementation showing operation of a summarization module 116 of FIG. 1 in greater detail. FIG. 3 depicts an example 300 of an algorithm to generate one or more dialogue skeletons. FIG. 4 depicts an example 400 to configure a language model to perform dialogue summarization using dialogue skeletons as additional supervision. FIG. 5 depicts an example 500 of generation of summaries of an input dialogue using models configured with a variety of training schemes in accordance with the techniques described herein. FIG. 6 is a flow diagram depicting an algorithm as a step-by-step procedure 600 in an example implementation that is performable by a processing device to generate a summary of a dialogue. FIG. 7 is a flow diagram depicting an algorithm as a step-by-step procedure 700 in an example implementation that is performable by a processing device to train a language model for dialogue summarization using dialogue skeleton supervised prompt transfer.

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-7.

FIG. 2 depicts a system 200 in an example implementation showing operation of a summarization module 116 in greater detail. Generally, the summarization module 116 is operable to receive a language model 202, e.g., a pretrained language machine learning model, and configure the language model 202 to generate summaries 118 of a corpus of text, such as one or more dialogues 122. In various examples, the summarization module 116 trains the language model 202, such as by using a dialogue-skeleton supervised prompt transfer approach between one or more source tasks and one or more target tasks as further described below.

For example, the summarization module 116 includes a training module 204 that is operable to receive a training dataset that includes a plurality of training dialogues 206 (block 602). The training dialogues 206 include a transcript, e.g., a transcript of a conversation from a particular domain between two or more parties that has multiple dialogue turns. A dialogue turn represents a unit of conversation such one or more sentences/utterances between a first party and a second party. For instance, a dialogue turn includes a “back-and-forth” between two or more participants in the dialogue.

In various examples, the training dialogues 206 are annotated such that in addition to a transcript, each training dialogue 206 includes a ground truth annotation related to one or more natural language processing tasks, e.g., that indicates a desired output for a respective task. For instance, one or more of the training dialogues 206 include dialogue state annotations for the dialogue turns that relate to a dialogue state tracking (DST) task. As further described below, dialogue states generally represent content and/or a context of a particular dialogue turn, and capture information exchanged between one or more parties throughout the conversation. Thus, the dialogue state annotations include information such as a user's goal, a query, a task being discussed, a context of a portion of the dialogue, relevant entities or attributes, key data or information that has been provided, etc. for dialogue turns of training dialogues 206.

Traditionally, DST is a language understanding task, e.g., comprehending and extracting meaning from language inputs. Accordingly, in some examples the dialogue state annotations are in the form of semantic slot value pairs ([slot, value]), for example [food, Italian], [price range, high], etc. However, to connect the DST task with a language generation target task such as dialogue summarization, in various examples the training module 204 is operable to treat DST as a sequence-to-sequence generation task. For instance, the training module 204 configures the language model 202 to generate a sequence of tokens for the DST task, e.g., “slot1 is value1, slot2 is value 2, . . . ” Thus, the dialogue state annotations include a sequence of tokens rather than slot value pairs. In this way, the techniques described herein promote effective knowledge transfer between DST and dialogue summarization as further described below.

Additionally or alternatively, one or more of the training dialogues 206 include annotations for dialogue summarization such as training summaries. For example, a particular training dialogue 206 includes a training summary that is a concise representation of key information from the particular training dialogue 206. However, annotations for dialogue summarization are computationally expensive and/or time-consuming to generate and thus are impractical to obtain in a variety of real-world contexts. Accordingly, in one or more examples, the training dialogues 206 that include training summaries represent a few-shot, low-shot, and/or no-shot context.

That is, the number of training dialogues 206 that are associated with training summaries are inadequate to train a machine learning model to accurately perform dialogue summarization using conventional techniques. Whereas annotations for dialogue summarization are relatively scarce, annotated training data for dialogue state information is readily available. Accordingly, in various examples the training dialogues 206 that include annotations for dialogue states outnumber the training dialogues 206 that include training summaries, e.g., by a ratio of 100:1 or greater.

The training module 204 further includes a skeleton module 208 that is operable to generate dialogue skeletons 210 based on the training dialogues 206 (block 604). The dialogue skeletons 210 include a subset of dialogue turns extracted from training dialogues 206, such as a subset of dialogue turns that a machine learning model is sensitive to. Sensitivity, for instance, refers to “how much” various dialogue turns influence an output of a machine learning model relative to other dialogue turns for the source task. In one or more examples, the skeleton module 208 determines sensitivity using a machine learning model that is configured to perform DST, e.g., a DST model 212. In some implementations, the DST model 212 is the language model 202 that has been configured for a DST task. Alternatively or additionally, the DST model 212 is distinct from the language model 202. To generate the dialogue skeletons 210, the skeleton module 208 generates one or more perturbation-based probes that are configured to determine a sensitivity of the DST model 212 to individual dialogue turns of the training dialogues 206. In this way, the skeleton module 208 identifies dialogue turns that the DST model 212 is sensitive to and generates the dialogue skeletons 210 to include dialogue turns that are over a threshold level of sensitivity.

FIG. 3 depicts an example 300 of an algorithm 302 implementable by the summarization module 116 to generate one or more dialogue skeletons 210. In this example, the skeleton module 208 leverages the algorithm 302 to generate dialogue skeletons 210 for each training dialogue 206. In the illustrated example, individual dialogue skeletons 210 are represented as sᵢ, and a set of all dialogue skeletons is represented as S. Further, xᵢ is a particular training dialogue 206, and X is the training dataset of all training dialogues 206 such that xᵢ∈X. The skeleton module 208 generates the dialogue skeletons 210 using one or more perturbation-based probes.

To generate perturbation-based probes for the particular training dialogue 206, the skeleton module 208 deletes dialogue turns from the particular training dialogue 206, one by one. Thus, each of the perturbation-based probes represents the particular training dialogue 206 with a dialogue turn tᵢⱼ removed. In this example, the perturbation-based probes are represented as xᵢ\[tᵢⱼ], 1≤j≥pᵢ where xᵢ includes pᵢ number of dialogue turns. Accordingly, the skeleton module 208 generates a number of perturbation-based probes equivalent to the number of dialogue turns in the particular training dialogue 206, e.g., pᵢ perturbation-based probes.

Once generated, the skeleton module 208 inputs the perturbation-based probes to the DST model 212, represented as LM_{DST} in this example, to generate model outputs. In various examples, LM_{DST} is the language model 202 that is configured for a DST task. The model outputs in this example are represented as oᵢⱼ, that correspond to perturbation-based probes with tᵢⱼ removed. Because the model LM_{DST} is configured for DST, the model outputs include various dialogue states. In this example, the DST model 212 treats DST as a sequence-to-sequence generation task. The skeleton module 208 further generates a model output based on the particular training dialogue 206, represented as oᵢ. The model output oᵢ represents a “baseline” output, e.g., an output that is based on an unedited training dialogue xᵢ.

The skeleton module 208 then computes textual similarity scores mᵢⱼ between the model outputs based on the perturbation-based probes, denoted oᵢⱼ, and the model outputs based on the unedited training dialogue, denoted oᵢ. In this example, the textual similarity score is based on a textual similarity metric, e.g., Sim(·,·), wherein a greater value correlates to a greater degree of similarity. Accordingly, in this example similarity and sensitivity are inversely related. For instance, a relatively high textual similarity score indicates that the DST model is not sensitive to the dialogue turn removed from a particular perturbation-based probe, e.g., the model output remains relatively constant despite removal of the dialogue turn. On the other hand, a relatively low textual similarity score indicates that the DST model is sensitive to the deleted dialogue turn, e.g., there is a significant difference between the model output oᵢⱼ and the model output oᵢ when a particular dialogue turn is not included in a perturbation-based probe.

The skeleton module 208 repeats this process for each of the training dialogues 206 in the training dataset X, such that each training dialogue 206 is associated with a plurality of perturbation-based probes and corresponding textual similarity scores. In this way, the skeleton module 208 uses the perturbation-based probes to determine dialogue turns from each training dialogue 206 that the model LM_{DST} is sensitive to. The skeleton module 208 then generates the dialogue skeletons 210 to include the dialogue turns that are associated with (e.g., deleted from) perturbation-based probes that are below a similarity threshold, and thus include dialogue turns that LM_{DST} is sensitive to.

In this example, the similarity threshold is based on a median textual similarity score. For instance, the skeleton module 208 is operable to calculate a median textual similarity score based on textual similarity scores generated for each of the training dialogues 206 in the training dataset X. The skeleton module 208 extracts dialogue turns that are below the median textual similarity score. This is by way of example and not limitation, and a variety of ways to configure the similarity threshold are considered. In this way, the skeleton module 208 generates a dialogue skeleton 210 for each of the training dialogues 206 to include dialogue turns that the DST model 212 is sensitive to. The dialogue skeletons 210 represent an intermediate task-specific medium between a source task (e.g., DST) and a target task (e.g., dialogue summarization) and are usable by the summarization module 116 as additional supervised training data as further described below.

For instance, the training module 204 trains the language model 202 to perform dialogue summarization using prompt transfer between a source task and a target task (block 606). Generally, the prompt transfer approach includes transfer learning, e.g., leveraging information from the source task to improve learning and/or performance of the language model 202 on the target task. Transfer learning overcomes limitations related to data scarcity, such as in examples in which training data is readily available in the source task but is scarce or doesn't exist for the target task. However, conventional transfer learning techniques are limited by a similarity of a source task and a target task. For instance, conventional transfer learning techniques are not usable for source and target tasks with dissimilar objectives, e.g., between language understanding tasks and language generation tasks. As further described below, the training described herein overcomes these limitations to improve model performance by using the dialogue skeletons 210 as additional supervision which provides an intermediate task-specific medium between the source task and the target task.

The prompt transfer approach further includes prompt tuning techniques, e.g., configuring one or more prompts that are able to guide the language model 202 during subsequent inferencing. For instance, the training module 204 fixes/freezes parameters of the language model 202 while learning a soft prompt 214. The soft prompt 214 includes a sequence of continuous trainable embeddings. Once trained, the soft prompt 214 is included (e.g., prepended, appended, combined, etc.) with an input to the language model 202 to influence the language model 202 to generate desirable outputs during inferencing, e.g., by providing the language model 202 with context to “steer” the language model 202 towards particular outputs. As part of the prompt transfer approach, the training module 204 learns one or more intermediate soft prompts during training on the source task and uses the intermediate soft prompts from the source task to initialize parameters of a soft prompt 214 to perform the target task.

In one example, the source task is a DST task for a particular domain and the target task is a dialogue summarization task for the particular domain. DST is informative for the dialogue summarization task in that dialogue states are likely to be included in a summary 118 of a dialogue 122, e.g., to convey key information from the dialogue 122. Further, dialogue state annotations are readily available for a wide variety of domains and are computationally inexpensive to obtain whereas dialogue summarization annotations are relatively scarce. However, there is a domain shift between DST and dialogue summarization that inhibits conventional knowledge transfer between the two tasks. While in this example, the source task is DST and the target task is dialogue summarization, the techniques described herein are extensible to a variety of natural language processing tasks.

Accordingly, the training module 204 is operable to configure the DST task as a sequence-to-sequence generation task to promote effective knowledge transfer between DST and dialogue summarization. To further bridge the gap between the two tasks, the training module 204 is operable to incorporate a skeleton generation task, using the dialogue skeletons 210 as supervision, for either or both the source task and/or the target task as further described below. Accordingly, in various examples annotations from the training dialogues 206 (e.g., dialogue state annotations and/or training summaries) are used as supervision for the training and the dialogue skeletons 210 are used as additional supervision for various aspects of the training process.

FIG. 7 is a flow diagram depicting an algorithm as a step-by-step procedure 700 in an example implementation that is performable by a processing device to train a machine learning model to perform dialogue summarization using dialogue skeletons 210 as supervision. In various embodiments, one or more steps of the procedure 700 are performed as substeps of block 606. In this example, the training module 204 implements several rounds of prompt tuning and/or prompt transfer to train the language model 202, e.g., to generate the soft prompt 214. For instance, the training module 204 implements a first step to perform prompt tuning on the source task, e.g., DST, using annotations of the training dialogues 206, e.g., the dialogue state annotations, as supervision to generate a first intermediate soft prompt that is based on the source task (block 702). The first intermediate soft prompt represents a sequence of continuous trainable embeddings. The prompt tuning thus includes optimizing parameters of the first intermediate soft prompt directly in a continuous space.

As a second step, the training module 204 performs prompt transfer using the first intermediate soft prompt to initialize parameters of a second intermediate soft prompt (block 704). Thus, the second intermediate soft prompt inherits information learned during the first step of training. The training module 204 then performs prompt tuning to refine the second intermediate soft prompt using the annotated training dialogues (e.g., with dialogue state annotations) as supervision for the source task as well as using the dialogue skeletons 210 as supervision for a skeleton generation task. For instance, the training module 204 incorporates the skeleton generation task into the source task as an additional level of supervised learning.

Continuing the above example, the training module 204 implements a third step to perform prompt transfer using the second intermediate soft prompt to initialize parameters of a third intermediate soft prompt (block 706). As above, the third step of training inherits information learned during the second step of training, and by extension the first step. The training module 204 then performs prompt tuning on the target task, e.g., dialogue summarization, to refine the third intermediate soft prompt using the annotated training dialogues 206 as supervision for the target task as well as using the dialogue skeletons 210 as supervision for the skeleton generation task. In this example, the target task is supervised using training summaries associated with several of the training dialogues 206, which represents a few-shot context.

As a fourth step, the training module 204 performs prompt transfer using the third intermediate soft prompt to initialize parameters of a fourth intermediate soft prompt (block 708). In this way, the fourth intermediate soft prompt inherits information learned during the preceding first, second, and third steps of training. The training module 204 then performs prompt tuning on the target task, e.g., dialogue summarization, to refine the fourth intermediate soft prompt using the annotated training dialogues 206 as supervision in a few-shot context. The resulting soft prompt generated after the four steps described above, for instance, is the soft prompt 214 that is usable in subsequent inferencing to guide the language model 202.

By using the dialogue skeletons as additional supervision, such as in the second step and third step, the training module 204 exposes the model to dialogue turns that the model is sensitive to in multiple contexts, which increases efficacy of parameter optimization of the soft prompt 214. Further, use of the dialogue skeletons 210 as additional supervision increases overlap between the two tasks and enables model sensitivity information to be explicitly passed from the source task to the target task during prompt transfer. In this way, the dialogue skeletons serve to “bridge the gap” between the source task and the target task during prompt transfer and overcome limitations of conventional transfer learning techniques, which are unable to effectively leverage knowledge between language understanding tasks (e.g., DST) and language generation tasks, such as dialogue summarization.

While in the above example the dialogue skeletons 210 are incorporated as additional supervision for both the source task and the target task, this is by way of example and not limitation. In various examples, the training module 204 leverages the dialogue skeletons 210 as supervision for either the source task or the target task. For instance, the training module 204 is operable to omit one or more of the steps described above to train the language model 202, as further described below.

FIG. 4 depicts an example 400 to train the language model 202, for instance to generate a soft prompt 214 that is usable during inferencing to adjust an input sequence to the language model 202 in a first stage 402 and a second stage 404. In this example, a source task is DST and a target task is dialogue summarization. In the first stage 402, a dialogue x that includes five dialogue turns (t₁, t₂, t₃, t₄, t₅) is depicted. In accordance with the techniques described above, the summarization module 116 generates a dialogue skeleton s for the dialogue x that includes dialogue turns that are above a threshold level of sensitivity. As illustrated, a model LM_{DST}, e.g., the DST model 212, is sensitive to the second and fifth dialogue turns, t₂ and t₅. Accordingly, the dialogue skeleton s includes t₂ and t₅. While one dialogue skeleton is depicted, in various examples the summarization module 116 generates a plurality of dialogue skeletons 210, e.g., one for each training dialogue 206.

In the second stage 404, the training module 204 is operable to leverage the dialogue skeletons 210 to train the language model 202, depicted as PLM. In this example, a first step 406, a second step 408, a third step 410, and a fourth step 412 are illustrated. Further, three training variants are depicted. For instance, a solid line represents a training scheme in which the dialogue skeletons 210 are incorporated as additional supervision for both the source task and the target task, denoted in this example as skeleton-assisted prompt transfer (SAPT) [DST+Summ]. A dotted line represents a training scheme in which the dialogue skeletons are incorporated as additional supervision for the source task, denoted SAPT [DST]. For instance, SAPT [DST] omits the third step 410. A dashed line represents a training scheme in which the dialogue skeletons are incorporated as additional supervision for the target task, denoted SAPT [Summ], which omits the second step 408.

In this example, (x, y) represents a supervised sample where x represents a dialogue (e.g., a training dialogue 206) while y represents a ground truth. For instance, y^{dst} represents a ground truth for DST, such as dialogue state annotations for a particular training dialogue 206, while y^{summ} represents a ground truth for dialogue summarization such as one or more training summaries. Because of a difference between the two tasks, conventional techniques are unable to effectively leverage transfer learning between DST and dialogue summarization. To overcome these limitations, the techniques described herein treat DST as a sequence-to-sequence generation task, and further use the dialogue skeletons 210 as an intermediate task-specific medium to support cross-task knowledge transfer.

For instance, a particular dialogue x that has p dialogue turns t such that x=[t₁, t₂, . . . , tₚ]. A dialogue skeleton s associated with x has q dialogue turns (q≤p) and is denoted as s=[t₁^{s}, t₂^{s}, . . . , t_{q}^{s}] such that thus set(s)⊆set(x). The training module 204 is operable to append the dialogue skeleton s to the original task supervision y (e.g., y^{dst} and/or y^{summ}) as extra supervision, and the language model 202 is trained to perform the original task as well as skeleton generation. Accordingly, a log-likelihood training objective for skeleton supervised training is defined as:

$${max}_{ϕ} log {p}_{θ , ϕ} ( y ⊕ s \vert x ) = log {p}_{θ , ϕ} ( y \vert x ) + log {p}_{θ , ϕ} ( s \vert x , y ) = log {p}_{θ , ϕ} ( y \vert x ) + {\sum }_{i = 1}^{q} log {p}_{θ , ϕ} ( {t}_{i}^{s} \vert x , y , {t}_{< i}^{s} )$$

where ϕ represents parameters of the soft prompt 214 and θ represents parameters of the language model 202.

In the illustrated example, the parameters θ of the PLM are frozen, while parameters ϕ of various intermediate soft prompts are learnable at each training step. For instance, at first step 406 the training module 204 performs prompt tuning on the DST task using dialogue state annotations y^{dst} as supervision to train a first intermediate soft prompt. In various examples, a log-likelihood training objective for prompt tuning not using the skeletons as supervision (such as in the first step 406 and the fourth step 412) is defined as:

$$max log {p}_{θ ϕ} ϕ ( y \vert x ) = {\sum }_{i = 1}^{\vert y \vert} log {p}_{θ ϕ} ( {y}_{i} \vert x , {y}_{< i} )$$

where y=y^{dst} for prompt tuning on the DST task and y=y^{summ} for prompt tuning on the dialogue summarization task.

At a second step 408, the training module 204 performs prompt transfer using the first intermediate soft prompt to initialize parameters of a second intermediate soft prompt. The training module 204 then performs prompt tuning to refine the second intermediate soft prompt using y^{dst} as supervision for the DST task as well as using the dialogue skeletons s as supervision for the skeleton generation task. As illustrated, SAPT [Summ] omits the second step 408 and instead performs prompt transfer between the first intermediate soft prompt and a soft prompt generated in the third step 410.

At the third step 410, the training module 204 performs prompt transfer using the second intermediate soft prompt to initialize parameters of a third intermediate soft prompt. The training module 204 then performs prompt tuning to refine the third intermediate soft prompt using y^{summ} as few-shot supervision for dialogue summarization as well as incorporating the dialogue skeletons s as supervision for the skeleton generation task. As illustrated, SAPT [DST] omits the third step 410 and instead performs prompt transfer between the second intermediate soft prompt and a soft prompt generated in the fourth step 412.

At the fourth step 412, the training module 204 performs prompt transfer using the third intermediate soft prompt to initialize parameters of a fourth intermediate soft prompt. The training module 204 then performs prompt tuning on the dialogue summarization task to further refine the fourth intermediate soft prompt using y^{summ} as supervision in a few-shot context. The resulting soft prompt generated by the four steps 406-412 described above, for instance, is the soft prompt 214 usable in subsequent inferencing to guide the language model 202. In this way, the techniques described herein support training of a language model 202 for dialogue summarization in a low-shot/few-shot context, and further conserves computational resources relative to conventional techniques that rely on large training datasets to update parameters of the models themselves during training.

Accordingly, the summarization module 116 is operable to receive the trained language model 202 and an input 120 that includes a dialogue 122 (block 608). The dialogue 122, for instance, includes a transcript of a conversation between two or more parties. While in this example, the input 120 includes a dialogue 122, this is by way of example and not limitation and the techniques described herein are applicable to generate summaries of a variety of text inputs. Accordingly, in one or more embodiments the input 120 includes a variety of text-based documents. In one example, the language model 202 is a transformer-based encoder-decoder pretrained language model. Additionally or alternatively, the language model 202 is a BART-large model such as described by Lewis, et al. BART: Denoising sequence-to-sequence pre-training for natural language generation, translation, and comprehension. In Proceedings of the 58th Annual Meeting of the Association for Computational Linguistics, pp. 7871-7880 (2020). This is by way of example and not limitation, and a variety of suitable language models are considered.

The summarization module 116 then generates a summary 118 of the dialogue 122 using the language model 202 (block 610). Generally, the summary 118 includes relevant information from the dialogue 122 and represents key content of the dialogue 122 in a concise manner. In various examples, the language model 202 is operable to generate the summary 118 by configuring an input sequence to include the soft prompt 214.

For example, the language model 202 generates an embedding based on the dialogue 122 for inclusion in the input sequence. The language model 202 further incorporates the soft prompt 214, which has been optimized in accordance with the training process described above, with the embedding, such as by prepending and/or appending the soft prompt 214 to the embedding. Thus, the language model 202 generates the input sequence to include the soft prompt 214 as well as the embedding of the dialogue 122. In this way, the soft prompt 214 is able to guide the language model 202 during inferencing, such as to steer the language model 202 to generate desirable outputs. By leveraging information from the DST task, the techniques described herein overcome limitations of conventional techniques associated with data scarcity, and further support generation of summaries that incorporate dialogue state information which is not possible using conventional approaches.

FIG. 5 depicts an example 500 of generation of summaries of an input dialogue using models configured with a variety of training schemes in accordance with the techniques described herein. In this example, the summarization module 116 receives a dialogue 122 that includes a transcript of a conversation between two parties, e.g., a user and a travel agent, and pertains to a request to reserve a taxi for a specific time between two locations. As illustrated, information related to dialogue states of the dialogue 122 is emphasized (bold and underlined) and utterances by the travel agent are italicized.

A first example summary 502 is generated by a machine learning model trained without using dialogue skeletons 210 as supervision. Accordingly, the first example summary 502 is missing information related to several of the dialogue states of the dialogue 122. For instance, the first example summary 502 does not include relevant information related to the first destination, e.g., where the user is to be picked up by the taxi. The first example summary 502 further does not include information related to the user's request to provide the vehicle type and the phone number.

A second example summary 504 is generated by a machine learning model trained using SAPT [DST] and a third example summary 506 is generated by a machine learning model trained using SAPT [Summ]. As described above with respect to FIG. 4, the SAPT [DST] training approach uses dialogue skeleton supervision solely for the DST task while SAPT [Summ] leverages dialogue skeleton supervision solely for the dialogue summarization task. As illustrated, the second example summary 504 and the third example summary 506 represent an improvement over the first example summary 502. For instance, the second example summary 504 and the third example summary 506 both include information related to the pickup time, destination, vehicle type, and phone number. However, the second example summary 504 and the third example summary 506 do not include information about the pickup location.

A fourth example summary 508 is generated by a machine learning model trained using SAPT [DST+Summ]. That is, the training includes incorporating dialogue skeletons 210 as supervision for both the DST task and the dialogue summarization task. By using the dialogue skeletons 210 as supervision for both tasks, the techniques described herein are able to better connect the DST task with the dialogue summarization task, and thus preserve information learned during training on the source task. Accordingly, in this example the fourth example summary 508 includes information related to each of the emphasized dialogue states, such as the pickup location, pickup time, destination, vehicle type, and contact number. Thus, the techniques described herein provide a modality to generate summaries in a few-shot scenario that further include dialogue state information from input dialogues, which is not possible using conventional approaches.

### Example System and Device

FIG. 8 illustrates an example system generally at 800 that includes an example computing device 802 that is representative of one or more computing systems and/or devices that implement the various techniques described herein. This is illustrated through inclusion of the summarization module 116. The computing device 802 is configurable, for example, as a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812. The memory/storage 812 represents memory/storage capacity associated with one or more computer-readable media. The memory/storage 812 includes volatile media (such as random-access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices 802 and/or processing systems 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a language model configured to generate summaries of dialogues, the language model trained using training dialogues and dialogue skeletons generated based on the training dialogues as supervision in a prompt transfer approach between a source task and a target task;
receiving, by the processing device, an input including an input dialogue; and
generating, by the processing device, a summary of the input dialogue using the language model.

2. The method as described in claim 1, wherein the source task is a dialogue state tracking task for a particular domain and the target task is a dialogue summarization task for the particular domain.

3. The method as described in claim 1, wherein the generating the summary includes configuring an input sequence to the language model to include a soft prompt generated during training of the language model based in part on the dialogue skeletons.

4. The method as described in claim 3, wherein the prompt transfer approach includes freezing parameters of the language model and learning parameters of the soft prompt.

5. The method as described in claim 1, wherein the prompt transfer approach includes learning a soft prompt for the source task and using the soft prompt from the source task to initialize parameters of a soft prompt for the target task.

6. The method as described in claim 1, wherein the dialogue skeletons include a subset of dialogue turns extracted from training dialogues using one or more perturbation-based probes.

7. The method as described in claim 6, wherein the one or more perturbation-based probes are configured to generate the dialogue skeletons by determining a sensitivity of a dialogue state tracking model to dialogue turns of the training dialogues.

8. The method as described in claim 7, wherein the subset of dialogue turns includes dialogue turns over a threshold level of sensitivity.

9. The method as described in claim 1, wherein the dialogue skeletons represent an intermediate task-specific medium between the source task and the target task.

10. A system comprising:
a memory component; and
a processing device coupled to the memory component, the processing device to perform operations comprising:
receiving a plurality of training dialogues, each training dialogue having a plurality of dialogue turns;
generating dialogue skeletons that include a subset of dialogue turns for each training dialogue using one or more perturbation-based probes; and
training a machine learning model to perform dialogue summarization using prompt transfer between a source task and a target task using the dialogue skeletons as supervision.

11. The system as described in claim 10, further comprising:
receiving an input including a dialogue; and
generating a summary of the dialogue using the trained machine learning model.

12. The system as described in claim 10, wherein the source task is a dialogue state tracking task and the target task is a dialogue summarization task.

13. The system as described in claim 10, wherein the one or more perturbation-based probes are configured to determine a sensitivity of the machine learning model to dialogue turns for a particular training dialogue, and wherein the subset of dialogue turns includes dialogue turns over a threshold level of sensitivity.

14. The system as described in claim 10, wherein the machine learning model includes a pretrained language model, and the training includes freezing parameters of the pretrained language model and generating a soft prompt to adjust an input sequence to the pretrained language model.

15. The system as described in claim 14, wherein the training includes using the dialogue skeletons as supervision to refine the soft prompt as part of the prompt transfer for both the source task and the target task.

16. The system as described in claim 14, wherein the training includes using the dialogue skeletons as supervision to refine the soft prompt as part of the prompt transfer for either the source task or the target task.

17. A non-transitory computer-readable storage medium storing executable instructions, which when executed by a processing device, cause the processing device to perform operations comprising:
receiving a language model configured using a prompt transfer approach between a dialogue state tracking task and a dialogue summarization task, the prompt transfer approach including using dialogue skeletons as supervision;
receiving an input including an input dialogue; and
generating a summary of the input dialogue using the language model based on the input dialogue and a soft prompt generated as part of the prompt transfer approach.

18. The non-transitory computer-readable storage medium as described in claim 17, wherein the generating the summary includes prepending the soft prompt to an input sequence generated based on the input dialogue.

19. The non-transitory computer-readable storage medium as described in claim 17, wherein the dialogue skeletons include a subset of dialogue turns extracted from training dialogues using one or more perturbation-based probes.

20. The non-transitory computer-readable storage medium as described in claim 19, wherein the one or more perturbation-based probes are configured to generate the dialogue skeletons by determining a sensitivity of a dialogue state tracking model to dialogue turns of the training dialogues.
